(19) United States
(12) Patent Application Publication
(10) Pub. No.: US 2002/0149325 A1
(43) Pub. Date: Oct. 17, 2002

(54) Method and circuit arrangement for operating a sodium high-pressure lamp

(76) Inventors: Michael Boenigk, Berlin (DE); Klaus Guenther, Berlin (DE)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/048,906

(22) PCT Filed: Jul. 9, 2001
(86) PCT No.: PCT/DE01/02549

(30) Foreign Application Priority Data
Jul. 10, 2000 (DE) 10033262.5

(51) Int. Cl. H05B 39/04

(52) U.S. Cl. 315/209 R; 315/224

(57) ABSTRACT

Sodium high-pressure lamps can be operated by a circuit arrangement which rectifies the AC line voltage and, dispensing with smoothing, feeds it directly to an inverter for generating a frequency above 1 kHz. Via an RF inductor and an ignition transformer, the lamp, which preferably contains a xenon filling above 1 bar, is fed the voltage modulated with twice the line frequency. The saving in electric energy of the lamp/ballast system is 30% by comparison with an inductor-driven Hg-free standard lamp, given the same luminous flux. The use of a microprocessor to control the half bridge permits an externally controlled or automatic lowering of power with a further potential energy saving of 35% on average over the year, and an end-of-life shutdown of the system in order to avoid cycling.

### TECHNICAL FIELD

The invention proceeds from a method for operating a sodium high-pressure lamp in accordance with the preamble of claim 1. In particular, these are mercury-free sodium high-pressure lamps with a relatively high xenon pressure (cold filling pressure of more than 1 bar) and with a low power (at most 400 W). Furthermore, a circuit arrangement for implementing the method is also specified.

### PRIOR ART

Sodium high-pressure lamps are widespread in exterior lighting because of their high luminous efficiency, their high reliability and long service life. They normally contain a filling of sodium, mercury and xenon in a discharge vessel made from polycrystalline aluminum oxide. The sodium and mercury are mostly—but not necessarily—present in saturated form, that is to say a sump of liquid Na and Hg whose temperature determines the partial pressures, and thus the electrical and optical properties of the lamp, is located in the heated-up burner in the operating state. For optimum luminous efficiency, the Na partial pressure is brought to approximately 100 hPa, while in Hg-free lamps it is approximately 200 hPa. Xenon pressure can be raised from 20 to 100 . . . 500 hPa, the result being to improve the luminous efficiency by 10 . . . 15%. Appropriately matched ballasts already exist on the market for the purpose of providing the higher starting voltage then required.

A further rise in the luminous efficiency by an additional 15% is possible in the case of low-wattage sodium high-pressure lamps when the xenon pressure is raised to above 1 bar (EP-A 834 905). It is a disadvantage that the lamp requires a substantially higher starting voltage than installations to be found on the market provide and are compatible with.

It has repeatedly been attempted with only moderate success to improve the optical properties of a high-pressure lamp by using an electronic ballast. The system then generates a temporally constant luminous flux with a mostly stabilized power consumption which is, however, scarcely honored by the user. The basic design of such an EB is illustrated in FIG. 1. The line power is fed to a full-bridge rectifier (2) via an RF filter (1). A harmonic filter (3), which can be of active or passive configuration, effects a sinusoidal current profile and feeds the smoothing capacitor (4a), which feeds a constant DC voltage to the medium-frequency generator (5). Medium-frequency is always understood here as a frequency above 1 kHz (in particular between 1 and 200 kHz). The medium-frequency generator is advantageously designed as a half bridge, in particular with a frequency of between 10 and 40 kHz.

Because of the high capacitance required, the smoothing capacitor must be designed as an electrolytic capacitor which is subject to relatively rapid aging, particularly in the case of high operating temperatures. An inductor (6) limits the lamp current, and starting is effected by the starting unit (7). In order to avoid acoustic resonances in the lamp (11), it has so far been necessary for the medium frequency to be rectified again (8), smoothed (9) and converted with the aid of a full bridge (10) into a bipolar square-wave shape.

The substantial electronic outlay of the solutions leads to high costs of the equipment, and to limited reliability because of the many components. Although the current-limiting inductor (6) are designed to be substantially smaller and thus be subject to fewer losses than a conventional inductor, the power loss of these EBs can be reduced only from approximately 15 W to 10 W because of the relatively high number of active components in the current path (at least 4 switching components). This limits the possible rise in the system luminous efficiency from the start.

A method and a device for operating a sodium high-pressure lamp that avoids acoustic resonances have already been disclosed in document EP-A 744 883. In this case, a DC voltage derived from a voltage source is fed to an inverter which feeds the high-pressure discharge lamp via a current-limiting inductor. The inverter operates with an operating frequency of from 10 to 100 kHz, the output, power being modulated periodically by the nominal power, specifically with a frequency which is between 50 Hz and the operating frequency of the inverter. Use is made now and then of amplitude modulation for high-pressure discharge lamps in order to stabilize the discharge arcs and center them (EP-A 785 702), in order to achieve a high power factor of over 90% (U.S. Pat. No. 5,180,950), or in order to minimize an EB (U.S. Pat. No. 5,371,440).

The substantial electronic outlay of these known solutions leads to high costs for the equipment. Their reliability is limited by the many components. Moreover, a relatively high power loss of approximately 10 W is to be accepted. For these reasons, electronic ballasts have never so far become competitive for high-pressure discharge lamps, in particular for exterior lighting.

### SUMMARY OF THE INVENTION

It is an object of the present invention to provide a method in accordance with the preamble of claim 1 that improves the system luminous efficiency and maintenance of sodium high-pressure lamps, in particular the values for novel mercury-free or low-mercury sodium high-pressure lamps, and which provides a high starting voltage required in the case of a xenon filling pressure of >1000 hPa (1 bar). A further object is to specify a circuit arrangement which is suitable for the purpose and is cost-effective.

These objects are achieved by means of the characterizing features of claim 1 and 4, respectively. Particularly advantageous refinements are to be found in the dependent claims.

A description is given of an operating method and a corresponding circuit arrangement that is of simple and reliable design. The resulting equipment has a very low power loss and can be produced with very low costs. For this purpose, the invention dispenses with properties which entail high costs for implementation and which the user accords little significance.

This creates the precondition for marketing a sodium high-pressure lamp with a high Xe pressure of over 1 bar, which requires a system consisting of ballast, starting device, lamp base and holder that provides a raised starting voltage in a functionally reliable way. The hindrance threshold for introducing such a system can be overcome only by appropriately attractive properties. Raising the luminous efficiency by approximately 30% by comparison with the standard lamp, or 15% by comparison with the super version is not alone sufficient for this purpose. Standard lamps are to be understood here as lamps with a cold filling pressure of approximately 20 to 30 hPa, whereas in contrast super lamps have a cold filling pressure of xenon of from approximately 100 to 500 hPa. The lamp/ballast system is now attractive enough to be introduced to the markets only because of the cost-effective provision of a suitable EB.

An electronic circuit arrangement (FIG. 2) is proposed in which the supply voltage is not smooth, as usual, after being rectified, but is fed directly to the medium-frequency generator (5). The backup capacitor (4b) is intended to provide for the lamp during the zero crossings of the line voltage a minimum voltage which avoids interfering restarting peaks in the lamp voltage but, on the other hand, distorts the line current only so little that no harmonic filter is required. This is ensured when the product of the capacitance of the backup capacitor C_{S} and the mean impedance of the lamp R_{L} is smaller than 3 milliseconds. The current amplitude of the 3rd harmonic is then below the permissible 30% of the basic amplitude at 50 Hz, and it is possible to dispense with the harmonic filter. The backup capacitor can also be omitted in the case of lamps with a high xenon pressure (in particular approximately more than 2000 hPa (2 bar) and thus a high thermal inertia.

A medium-frequency generator (5) is operated in this way with a DC voltage modulated with 100 Hz (assuming a line frequency of 50 Hz), and outputs a medium frequency amplitude-modulated with 100 Hz to the lamp (11) via the current-limiting inductor (6) and the starting unit (7). Modulation thereby resulting of the luminous flux is insignificant for specific applications, in particular in exterior lighting.

This solution has a plurality of advantages: it is possible to dispense with an expensive harmonic filter. The circuit has extremely low losses, since there is only one switching element in the conduction path. It is more reliable than the known electronic ballasts, because it includes no age-sensitive electrolytic capacitors. The production costs for the circuit arrangement are of the order of magnitude of a conventional ballast with starting device. The amplitude modulation of the medium frequency reduces from the start the build up of acoustic resonances in the discharge vessel, without this requiring square-wave shaping. The drastic reduction in the inductance in the current path substantially reduces the restarting peaks in the lamp voltage that occur after the current zero crossing, or suppresses them entirely. If the medium-frequency generator is advantageously externally controlled with the aid of a microcontroller, this controller can be used immediately to implement further control functions desired by the user, such as half-night switching (also automatic) and end-of-life shutdown.

### FIGURES

The aim below is to explain the invention in more detail with the aid of an exemplary embodiment. In the drawings:

FIG. 1 shows a scheme of the conventional method (square-wave operation);

FIG. 2 shows a scheme of the method according to the invention;

FIG. 3 shows a circuit arrangement which implements the method according to FIG. 2; and

FIG. 4 shows current and voltage profiles for a lamp operated with the circuit arrangement according to FIG. 4.

### DESCRIPTION OF THE DRAWINGS

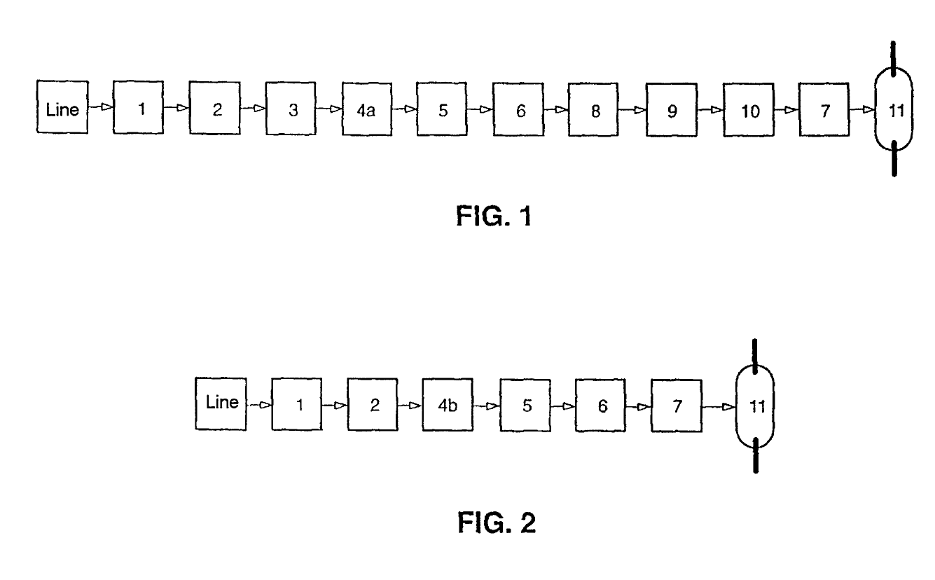

The design of the operating method is illustrated schematically in FIG. 2. The line power is fed to a full-bridge rectifier 2 via an RF filter 1. A backup capacitor 4b is connected to said rectifier. By contrast, it is possible to dispense with a harmonic filter 3 and the smoothing capacitor 4a of the conventional circuit FIG. 1, which in the prior art feeds a constant voltage to the medium-frequency generator 5. An inductor 6 limits the lamp current, and starting is effected by the starting unit 7.

Such a circuit arrangement was used for a 70 W sodium high-pressure lamp with a cold filling pressure of 2 bar xenon (without Hg), the operating frequency of the lamp being at 25 kHz, and the modulation at 100 Hz (that is to say double the line frequency).

Table 1 shows the saving for an arrangement according to the invention by comparison with conventionally operated sodium high-pressure lamps with a power of 70 W, given an identical luminous flux. It is to be seen that with the electronically operated mercury-free sodium high-pressure lamp with a xenon filling of 2 bar there is a saving by comparison with the conventionally operated 70 W standard lamp with an elliptical outer bulb (E version) of approximately 30%, and that by comparison with the conventionally operated 70 W super lamp with a cylindrical outer bulb (T version) there is a saving of approximately 20% in the total electrical power. In the case of application to the invention to the lamp filled with mercury amalgam, the savings are even of approximately 50 and 35%, respectively.

TABLE 1

| | 70 W E | 70 W E | 70 W T | 70 W T |
|---|---|---|---|---|
| | Standard | Standard | Super | Super |
| | ref. | Hg-free | ref. | Hg-free |
| Type of lamp | lamp | lamp | lamp | lamp |
| Luminous flux (lm) | 5600 | 5630 | 6500 | 6500 |
| Power (W) | 70 | 57 | 70 | 65 |
| Luminous efficiency | 80.0 | 98.8 | 92.9 | 100.0 |
| (lm/W) | | | | |
| Type of ballast | CB | EB | CB | EB |
| Power loss (W) | 17 | 4 | 17 | 4 |
| Luminous efficiency of | 64.4 | 92.3 | 74.7 | 94.2 |
| the system (lm/W) | | | | |
| Total power of the | 87 | 61 | 87 | 69 |
| system (W) | | | | |
| Saving by comparison | | 30% | | 21% |
| with CB | | | | |

As proposed, the medium-frequency generator is externally controlled with a microcontroller which according to the invention additionally implements a lowering of power, controlled or programmed by the operator, during the time of low traffic volume. In this case, the power is lowered by means of a gradual rise in frequency of the medium-frequency generator so slowly that during this operation the lamp voltage does not rise. The time required for this is 1 . . . 5 min. This measure lowers the system power by a further 35% on average over the year.

Furthermore, via an A/D converter input the micro-controller monitors the lamp voltage and switches the lamp off permanently upon a rise in voltage shortly before the cycling state. Cycling is understood as the repeated extinction of the lamp by raising the operating voltage and restarting after cooling.

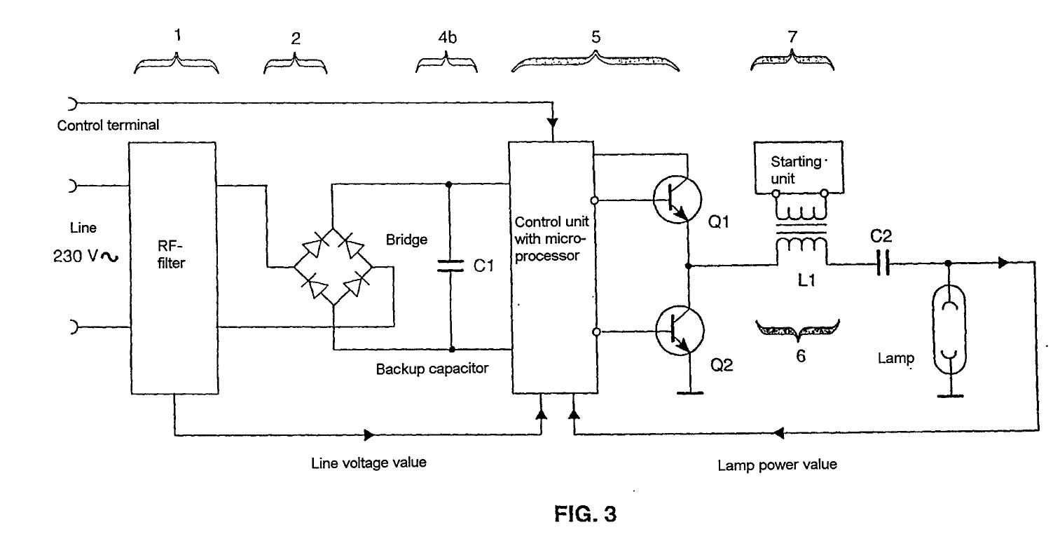

Shown in detail in FIG. 3 is a circuit arrangement which implements the above operating method (in accordance with FIG. 2). It has the following design:

Design and function correspond to the above statements. The frequency generator 5 is designed as a half bridge made from two transistors Q1, Q2 with microprocessor control (control unit), while the starting unit 7 is here, in particular, a superimposition starting device including the inductor 6. The control unit takes account as input of the line input voltage, the lamp power and the potential of the control terminal. The control terminal permits EB states such as full-load operation, dimming, etc. to be influenced.

Concrete values for the components used are to be found in the attached list 1.

List 1 of components (re FIG. 3)

| | |
|---|---|
| L1 | 0.5 mH |
| C1 | 470 nF |
| C2 | 470 nF |
| Bridge | commercially available |
| Radio-frequency filter | commercially available |
| Q1 | commercially available with freewheeling diode |
| Q2 | commercially available with freewheeling diode. |

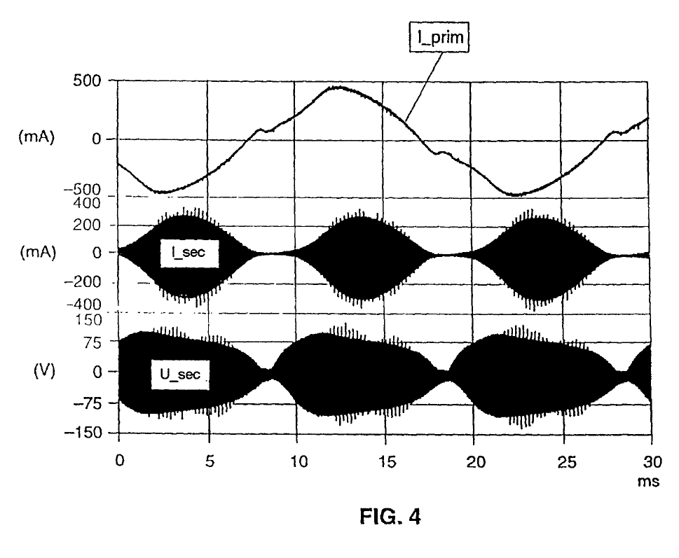

The line current (primary current I_prim) and lamp current (secondary current I_sec) are plotted, in mA in each case, as is the lamp voltage (U_sec) in V, in FIG. 4 as a function of time (in ms) for the arrangement in accordance with FIG. 3.

1. A method for operating a sodium high-pressure lamp on line voltage with a prescribed line frequency, characterized in that the lamp is operated with a frequency above 1 kHz, and the amplitude of this frequency is modulated with twice the line frequency.

2. The method as claimed in claim 1, characterized in that the lamp is operated with a frequency of between 1 and 200 kHz.

3. The method as claimed in claim 1, characterized in that the operating frequency is between 10 and 40 kHz.

4. A circuit arrangement for a method as claimed in claim 1, characterized in that the line voltage is fed to the lamp via a network, the network including the following components:
RF filter (1)
Rectifier (2)
Frequency generator (5)
Inductor (6), and
Starting device (7).

5. The circuit arrangement as claimed in claim 4, characterized in that a backup capacitor (4b) is arranged between the rectifier and frequency generator.

6. The circuit arrangement as claimed in claim 5, characterized in that the backup capacitor (4b) is dimensioned according to the following condition:
0≦Rₗₐₘₚ·x C_{backup}≦3 ms,
Rₗₐₘₚ meaning the time-averaged ohmic impedance of the lamp in the operating state, and C_{backup} being the capacitance of the backup capacitor.

7. The circuit arrangement as claimed in claim 4, characterized in the frequency generator is externally controlled by a microcontroller.

8. The circuit arrangement as claimed in claim 7, characterized in that the microcontroller lowers the lamp power as a reaction to an external control pulse or a programmed pulse by slowly raising the operating frequency.

9. The circuit arrangement as claimed in claim 4, characterized in that it contains no electrolytic capacitors.
